(19) United States
(12) Patent Application Publication
(10) Pub. No.: US 2008/0268206 A1
(43) Pub. Date: Oct. 30, 2008

(54) High Temperature Heat Resistant Adhesive Tape, with Low Electrostatic Generation, Made with a Polyetherimide Polymer

(76) Inventor: Raul Maldonado Arellano, San Luis Potosi (MX)

Correspondence Address: 3M INNOVATIVE PROPERTIES COMPANY, PO BOX 33427, ST. PAUL, MN, 55133-3427, US

(21) Appl. No.: 12/096,249

(22) PCT Filed: Dec. 19, 2006
(86) PCT No.: PCT/US06/48476

§ 371 Date: Jun. 5, 2008

Related U.S. Application Data
(60) Provisional application No. 60/743,076, filed on Dec. 23, 2005.

(51) Int. Cl. B32B 7/12; B29C 65/00; B32B 3/00

(52) U.S. Cl. 428/172; 428/343; 156/196

(57) ABSTRACT

Provided is a heat-resistant masking tape suitable for electronics applications comprising a polyetherimide polymer film having a first surface and a second surface, an adhesive on the first surface, and a low adhesion agent on the second surface, wherein at least one of the polyetherimide film, the low adhesion agent and the adhesive includes micronized carbon black. Also provided is a process for making this tape and electronic circuits using this tape.

### TECHNICAL FIELD OF THE INVENTION

This invention is related to construction of an adhesive tape with a composition that enables it to resist high temperature treatments and maintain a low electrostatic level when removed from a polymer or metal surface, through a combination of a polyetherimide polymer film and an adhesive of an acrylic or silicone type, which may be added to conductive materials of an organic polymer nature, organic or inorganic metallic salts, organic salts of organic compounds such as aniline, activated carbon or micronized carbon black.

This invention also involves a system whereby the aforementioned additives are added to the adhesive, as well as the equipment systems for applying the former to the polyetherimide polymer film.

### BACKGROUND OF THE INVENTION

Several alternatives have been described for building adhesive or non-adhesive tapes that maintain their stability in high temperature conditions; and which also contribute to maintaining a low electrostatic level when being supplied from a roll or dispatcher and applied to a specific surface. One of the main applications of these alternatives is to protect electric or electronic circuits when they are subject to high temperatures in a furnace or soldering machine; and only specific sections must be exposed. The stability of the adhesive tape must be ensured in such a way that the caloric energy has a greater impact, particularly in the section subject to change or processing. This type of procedure is known as masking or temporary protection, which is the most common procedure recommended for electric circuits, as insulating masking films; or in electronic circuits as gold fingers.

Bearing in mind the surfaces on which the masking adhesive films are placed, it is frequently important that the electrostatics formed by the friction of the adhesive surface and the backing film be reduced in order to prevent damage to the electric or electronic circuit through conduction when they come into contact with each other. There are products on the market that have been used for many years to protect electronic or electric circuits, against high temperature as well as the high electrostatic levels generated during handling. These products include those manufactured with a polyimide backing made by companies such as Dupont or ChengDu New HuaWei International Trade Limited, and which use a silicone-base adhesive based on the chemical structure of a siloxane polymer. These products include tapes 5419 and 5433 made by 3M Company, or the tapes manufactured by Qtek or Saint-Gobain.

There are also products such as tape 5563 made by 3M Company, which uses an acrylic adhesive that remains stable at temperature of up to 220° C. and has a polyimide film. This tape also has the ability to reduce the electrostatic charge when unwound from a master roll or when friction is produced against a metal surface during removal.

Within the current status of the technique, systems such as that of Takeuchi and Nakao in patent JP7176842 are described. They consist of a panel in which a polyimide film is placed, maintaining properties when subject to high temperatures. This system is dependant upon a reaction of components, which makes it more suitable for use as a whole plate that subsequently adjusts itself through mechanical means such as adhesives or screws. A system of polymers resistant to high temperatures is described in WO02092654 on polyimides that release a small amount of heat in low widths, are stable under ultraviolet light as well as at high temperatures, as alternatives to the Kapton commercial film produced by Dupont. This invention provides an alternative for high temperature heat-resistant films, even though it does not take into account an adhesive or mechanism to reduce the electrostatic charge generated by the friction caused by the film itself, or with a different material. There is a version of an adhesive tape resistant to organic solvents and to high temperatures, which is formed from a base solution that is placed on semiconductor materials as a thin film. This film is mentioned in Patent JP6340847 belonging to Ikeda et al., which also indicates the use of treatment prior to placement and represents additional energy consumption.

Another item described within current techniques is a tape that prevents a conductor material from being covered by the adhesive during sealing with a resin. The tape described in Patent JP6212134 belonging to Inagaki and Hara has a polyimide resin adhesive, an epoxy resin and an inorganic additive. This type of construction offers good resistance to chemicals and high temperatures, but construction is highly complex, which has limitations in temporary applications, in which the tape must be removed after a few minutes.

An invention such as that described in Patent EP0369408 belonging to Eguchi and Kuroda shows a polyimide film on which a very thin metal film, such as copper for example, is placed in such a way that the result is a flexible circuit that may be printed. This invention takes advantage of the high resistance of the polyimide polymer to manufacture circuits, but it does not have properties to reduce electrostatics. A application is described in Patent BE801115 belonging to Dupont, which consists of a polyimide film used to make laminates with an acrylic adhesive that makes it suitable for permanent fixture on metal surfaces.

One application generally found for high temperature heat resistant polymers and the chemical attack is described in Patent GB1383985 belonging to Rhone Polenc SA. In this application it is also indicated that the polyimide films may be used to join electronic circuit panels and to cover electric conductors. In this case the initial polyimide film must be covered with an additional polymer, which makes its production process complex and its cost very high.

Patent WO9620983 belonging to Gutman and Yau describes a tape focused more specifically toward use in electronics. It is comprised of a silicone adhesive tape that has conductive material resting on a polyimide film in the form of a thin coat. This construction makes the tape heat resistant and, in addition, reduces the electrostatics caused by friction against itself or against a surface made of a different material. This construction is used as a base for manufacturing tapes that are applied to electronic or electric circuits by taking advantage of the properties of the polyimide polymer, even when the later represents a material with limited supplies. A product is described in Patent JP2004136625, in which a tape is built based on a combination of conductive materials and resins that is able to act as a means of transport for electronic chips, transport of electronic circuits or bedding for printed electronic circuits. Likewise, in Patent JP20022069395 belonging to Miyako and Taima, there is an adhesive tape through placement of a coating of a conducting material over any material acting as a substrate, which might be a polyolefin. This application is especially important in cases where reduction of electrostatics is such that the tape must become a semiconductor. Patent JP2001152105 belonging to Ito and Kawada describes a conductive adhesive tape, but this time one that has three coats of material, including a melamine, a polyolefin and a fluoroalkylsilane, which makes it a product specifically for conducting electricity and limits it to non-temporary uses.

Work has been conducted on silicone adhesives to provide them with increased conductivity in such a way as to reduce the electrostatic discharge level generated during their use in electronic systems industries. Patent JP10120904 belonging to Hirano et al. describes an adhesive with a silicone base to which a boron compound is added. This type of adhesive eliminates the need to use a polyolefin or polyimide film or one of any other compound to reduce electrostatics. Nonetheless, its design does not allow it to maintain resistance to physical deformations or damages from direct blows. One version of a tape reduces electrostatics using a conduction system through small conductive strands on the very thin coat of adhesive protected by a paper or polyolefin film containing a low surface energy or anti-adherent agent. Although it is highly effective for conducting static electricity, this tape has limitations when a low-cost solution is required for protecting surfaces for a short period of time.

### OBJECTIVES OF THE INVENTION

Based on a review of the status of the technique consulted, an objective of certain embodiments of this invention is to build an adhesive tape that uses different adhesive compositions and a polyetherimide polymer film providing protection and insulation in electronic and electric applications, as well as in applications in which protection is needed for surfaces at the time they are subjected to high temperatures.

Another objective of certain embodiments of this invention is to offer various alternatives for designing construction of a protective adhesive tape that also reduces electrostatics.

Another goal of certain embodiments of the invention is to present manufacturing systems for producing the high temperature heat resistant adhesive tape.

### BRIEF DESCRIPTION OF THE INVENTION

The new invention can prevent mechanical damages to the adhesive and the covered surface due to the fact that the polyetherimide polymer film offers a barrier that is highly resistant to tension and the mechanical stress from the cut-die. At the same time, it provides a silicone or acrylic adhesive tape with the advantage that conducting materials may be added as transition metals, micronized carbon black or boron salts, which may easily be blended with a silicone-base adhesive to achieve a very thin coat on a polyetherimide polymer film. The micronized carbon refers to one carbon black used as powder and having a particle distribution between 1 and 50 microns, while the transition metals or boron salts present a particle size of 150 to 200 microns.

The polyetherimide is resistant to the mechanical stress encountered during its use as temporary protection for electronic and electric circuits; in addition to insulating the surface covered by the adhesive tape, thereby limiting contact with the outside environment, preventing propagation of static electricity and/or limiting contact with materials conducting electricity that might cause a short circuit.

This invention also includes the method for manufacturing the new adhesive tape in a simpler way, which shortens production time and ensures uniformity in the final characteristics. Thus a tape is obtained that uses a polyetherimide polymer, eliminating the use of polyimide and its derivatives; and an adhesive containing dispersed particles that contribute to reducing the electrostatic charge generated by friction between surfaces. In addition, its measurements and chemical structure remain stable under high temperature conditions.

In one aspect, the present invention comprises a film or backing, an adhesive, a low adhesion or anti-adherent agent (also known as LAB for Low-Adhesion-Backing), and agents that can modify electrostatic build-up.

In other aspects, the invention may include a primer or Corona treatment of the film or backing. In other aspects, the invention may include a system for applying the adhesive on the film or backing.

In all cases, the chemical composition may be altered, depending on the final application in which the product is to be used. In the case of the film or backing, the composition includes a polyetherimide polymer. Another option is to place a polyolefin or die-cut sheet of paper coated with a low adhesion compound over the adhesive in such as way that the adhesive takes on the geometrical shape of the die-cut or raised portions when the film or sheet is removed. This ensures that only a minimum of air remains between the adhesive and substrate material, and makes the adhesion contact more effective.

There have presented products to be used as protection for electronic or electric circuits, as well as products that can be used for conduction and dispersion of the electrostatics formed by friction of the adhesive tape or adhesive itself, with itself or with a different surface.

Several of these products are already being marketed by companies such as Nitto (Japan), 3M Company (U.S.A.), Q-tek Company (U.S.A.), Parmacel Company (U.S.A.) and Saint Gobain SA (France). These products are based on a polyimide polymer film; the preferred product is that offered by Dupont in the United States. The adhesive used in these cases is preferably a silicone derivative that is modified so that it constitutes a pressure-sensitive adhesive. Some of the aforementioned products also add electricity conduction materials to the adhesive, in the form of fine particles such as metallic salts that include silver, gold, copper, tin, zinc, iron or vanadium.

Although the aforementioned products are effective with regard to their resistance to heat and reduction of electrostatics, they do have the disadvantage that they are very expensive, they are limited to maximum temperatures of up to 180° C. and their use is restricted to permanent applications or more controlled environments in order to prevent the adhesive on the backing film from slipping off the tape.

This invention also involves construction of an adhesive tape using the new polyetherimide polymer and a silicone or acrylic base adhesive. It is processed through a simple pumping manufacturing system and the fact that it lowers production costs makes it feasible for use in simple, temporary applications, with resistance to temperatures up to 180° C., with the ability to reduce electrostatics.

Sometimes a primer or Corona treatment is needed to keep the adhesive on the film or backing, in order to improve the interaction between the film or backing itself and the adhesive. The theory regarding operation of the Corona treatment and primer has been widely analyzed and is well known among persons with an understanding of the art. Many different pieces of equipment and formulas are used to manufacture products such as labels, adhesive tapes, protective folios, medical tapes, etc.

The product of this invention also includes a low adhesion agent or LAB (low-adhesion-backing) on the other side of the film or backing, which prevents the adhesive from sticking or losing its adhesive quality. This agent has many different compositions but for this invention silicone or silicone and urea compounds are satisfactory.

Processes for manufacturing adhesive tapes or folios may be used to place the adhesive over the film or backing. The processes include those that use systems for melting an adhesive without organic solvent and those with systems for applying adhesives dissolved in organic solvents (toluene, heptane, ethyl acetate, etc.) or water. In all cases operating conditions for placing the adhesive will make it necessary to consider the nature of the film or backing and that of the adhesive. It is important to mention that for those with a knowledge of the art, the use of any current system or any created in the future that involves the elementary principle of placing a thin coat on a die-cut, raised portion section constitutes a derivation of this invention.

Manufacture of the product of this invention includes, but is not limited in its description or sequence to, the following:

1. Application of a Corona treatment or primer on at least one of the sides of the film or backing;
2. Application of a low adhesion agent on the side of the film or backing where the adhesive will be provided;
3. Drying the primer and the low adhesion agent in ovens or other drying equipment;
4. Placement of a thin coating of adhesive on the film or backing surface, following the contour of the die-cut or raised portions;
5. Substantial elimination of any solvent present in the adhesive or cooling of the melted adhesive;
6. Winding up of the tape in a master roll.

At present there are versions of adhesive tapes on the market that use polyimide polymers as a first choice. This invention uses polyetherimide polymer, which has sufficient properties to work as an alternative to polyimide and presents an equally competitive price. Thus a product is constructed that is functional in defined applications and yet does not have the problems pertaining to polyimide supplies.

Formation of small sphere-shaped or semi sphere-shaped capsules or particles, which contain the adhesive, constitutes one derivation of construction of the invention. Components marketed under the brand name Scotch Grip, manufactured by 3M Company, are found within this type, and they include products made with the technology presented by Scotch Grip 2353, Scotch Grip 2510, Precote 85, Precote 80 and Precote 30.

In addition, existence of a micro-replicated profile in the adhesive, through reproduction of the surface of the type of Scotch Cal® products manufactured by 3M Company makes it possible to offer an alternative that reduces flaws caused by a lack of contact between the adhesive and the substrate material, due to the presence of air.

### BRIEF DESCRIPTION OF THE DRAWINGS

FIG. 1 shows the different geometrical shapes and distributions of the cut-die or raised portions on the film or backing of this invention. These examples in shapes 1a, 1b, 1c, 1d, 1e, 1f and 1g are not the only ones possible; and they may include other geometrical shapes that construct a final product of the invention.

FIG. 2 shows the main thicknesses in the film or backing used: the total thickness of the film or backing on the raised portions (H) and the thickness of the base of same (h).

FIG. 3 shows the angle (i) that the die-cut or raised portions might have in the film or backing.

FIG. 4 shows a diagram of the finished protective adhesive film, comprised of an upper coat of adhesive (ii), a lower coat of adhesive (iii) and a film or backing with a die-cut or raised portions (iv).

FIG. 5 shows an example of the geometrical shapes in a film or backing with a die-cut or raised portions, and the span (v) that exists between them in order to obtain channels.

FIG. 6 shows a graph with the levels of electrostatics formed under conditions with 25° C. and 50% relative humidity when micronized carbon black and copper salts are added to the adhesive.

FIG. 7 shows the effect on the adhesion to steel, of additives to reduce electrostatics.

FIG. 8 shows a graph with the levels of electrostatics formed when micronized carbon and regular carbon black are added, in the extrusion of the polyetherimide film.

The following conditions were used for FIGS. 6 through 8: 25° C., 50% relative humidity, a conditioning time of 24 hours, detachment speed of 12 inches per minute and the Hewlett Packard static energy reader Mod. 2639, as gauging equipment for electrostatics.

### DETAILED DESCRIPTION OF THE INVENTION

This invention consists of a film or backing composed of polyetherimide, which may or may not have a die-cut or raised portions of different size or shape and maintains a thin coat of adhesive on its surface.

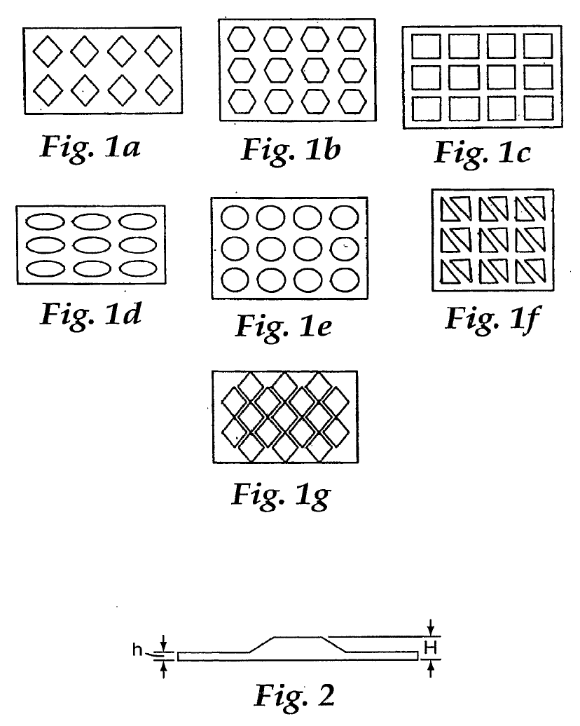

The film or backing may have various geometrical shapes on its cut-die or raised portions, as shown in FIGS. 1a, 1b, 1c, 1d, 1e, 1f and 1g. Likewise, the measurements of this die-cut may vary; although the ideal sizes, though not the only ones, are those shown in table 1:

TABLE 1
Measurements of the die-cut or raised proportion on the film or backing

| | | Length | |
|---|---|---|---|
| Geometrical shape on the | Depth | (or diameter) | Width |
| die-cut or raised proportion | (millimeters) | (millimeters) | (millimeters) |
| Polygon | 0.127-2.0 | 1.5-7.0 | 1.5-7.0 |
| Circle | 0.127-2.0 | 1.0-5.0 | — |

The die-cut or raised portions have dimensions that make it possible to place the adhesive on its surface, in various thicknesses that include a size similar to that of the die-cut or raised proportion itself. It is preferable for the dry adhesive to have the dimensions shown in Table 2 below, the objective of which is to show examples of recommended sizes although they are not the only ones applicable to the invention:

TABLE 2
Thickness of the dry adhesive on the die-cut or the flat
surface of the film backing

| Geometrical shape of the die-cut | Depth (mm) |
|---|---|
| Polygon | 0.127-1.2 |
| Circle | 0.127-1.2 |
| Flat surface | 0.05-2.0 |

It is important to point out that, as illustrated in FIG. 2, the measurements in H and h, pinpointed as the total thickness of the raised portions and the thickness of the film base, respectively, may vary depending on the requirements of the final application of the product of this invention. In any event, the existence of a thinner or thicker film or backing will be determined by the properties of the material of which it is composed, as well as by the ease with which it may be used in the final application sought.

It is preferable to use a pressure-sensitive adhesive (PSA), thereby making it possible to determine the thickness of the adhesive over the film or backing. Any person familiar with adhesives of any composition is able to understand that the amount of solids, adhesive power, removal power and other properties of an adhesive film are influenced by the chemical composition of the thickness of the adhesive chosen. Therefore, the thickness of the adhesive may range between about 0.0002 and about 0.002 inches (0.00508 and 0.0508 millimeters) for the product of this invention. Presently, the preferable amount is about 0.001 inches (0.0254 millimeters), or an amount equal to between about 3 and 35 grams per square meter based on the contents of the solids in the adhesive itself.

The adhesive compound in the product of this invention is a pressure-sensitive adhesive (PSA), a composition that is comprised mainly of a silicone-based polymer, preferably a solution containing polydimethylsiloxane and polysiloxane resin rubbers. Adhesives of an acrylic type may also be used, including blends with isooctylacrylate or 2-ethylhexylacrylate with acrylamide or acrylic acid, butyl acrylate and methacrylates, essentially.

In the event the tape use requires that the electrostatics be reduced, a conductive material may be added to the polyetherimide film forming extrusion process. The film with the properties shown in Table 3 in particular is an option for reducing electrostatics and maintaining good resistance to temperatures of up to 220° C.

TABLE 3
Properties of a polyetherimide film with a thickness
of 0.001 to 0.002 inches.

| Property | Testing method | |
|---|---|---|
| Tensile modulus | ASTM-D-882 | 2768 MPa |
| Resistance to breakage (machine direction) | ASTM-D-882 | 121.1 Mpa |
| Maximum elongation (machine direction) | ASTM-D-882 | 130.3% |
| Resistance to breakage (crossweb | ASTM-D-882 | 112.1 Mpa |
| direction) | | |
| Maximum elongation (crossweb | ASTM-D-882 | 1198.2% |
| machinery direction) | | |
| Shrinkage at 200° C. | GE | 0.4% |
| | International | |
| | Method | |

The features shown above illustrate what can be used but are not the only possibilities.

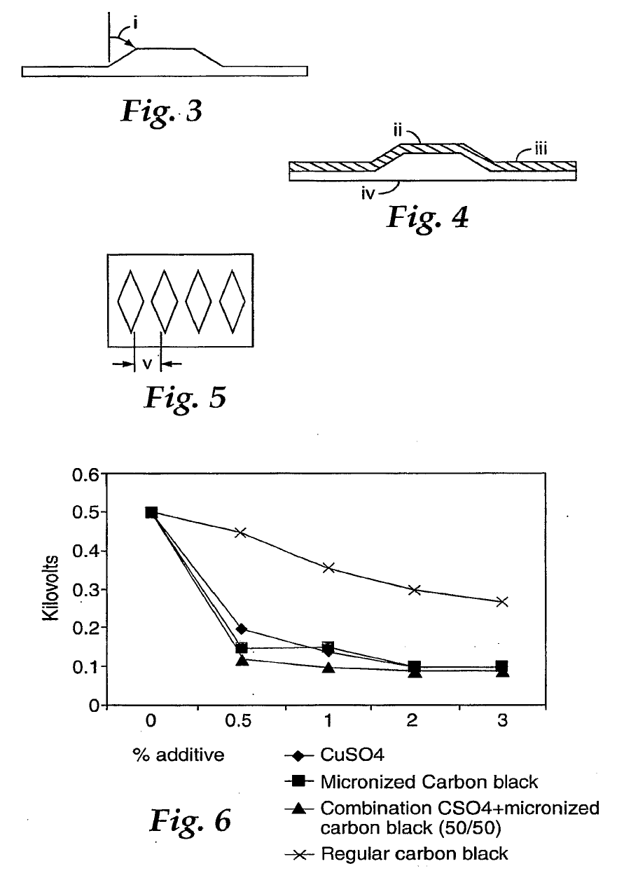

One important characteristic of the film die-cut or raised proportion is the angle at which the geometrical form may be constructed on the surface. This angle may range between 0° and 70° compared to the perpendicular of the film or backing base. This is shown in FIG. 3 and it demonstrates in a way that is easy to understand for persons familiar with the technique that the angle (i) may be altered in combinations with the depth of the die-cut or raised proportion shown in the different FIGS. 1a, 1b, 1c, 1d, 1e, 1f and 1g. The presence of the angle also makes the adhesive slide toward the bottom of the die-cut or raised proportion, depending on the slope. A steeper slope causes an increased amount of adhesive to slide to the bottom of the die-cut or raised proportion. Nonetheless, it is possible to control the flow capacity of the adhesive by altering the composition and formula of the adhesive used. In constructing the product of this invention, it is best to have most of the adhesive sustained on the upper surfaces of the die-cut or raised proportion (ii), leaving the smallest portion along the sides and bottom of the geometrical shape (iii) on the film or backing (iv), as shown in FIG. 4.

The adhesion properties of the final product are affected by the type of adhesive, the contact surface and the geometrical shape selected for the backing or film. A larger contact surface with an adhesive with a high instantaneous adhesive power can keep the product on glass, ceramic or steel surfaces. The contact surface of the film or backing that comes into contact with the adhesive and, in turn, the surface that is positioned over the protected surface also determines the power with which the product of the invention will stay firmly in place. In addition, the compositions of the adhesives used will help to reinforce the affinity and adhesion of the product on the reinforced surface. It is also important to point out that the type of adhesive must be selected according to the manufacturing process in which the film acting as reinforcement will be used. In cases in which the material to be reinforced drifts at high speeds, an adhesive with a high instant adhesive power will make it possible to rapidly join the surface in movement. Any combination of adhesive with an application process is valid, in accordance with the specific needs of the user.

Different combinations may be used between the type of film or backing and the adhesive. Any person with knowledge of the subject will be able to deduce that variations in the adhesive power on a given surface may be selected from a variety of combinations arising from this invention. Some examples that describe the adhesive powers stemming from combinations of an adhesive and film or backing are shown in Table 4. They are only some examples to illustrate possibilities, but are not the only options:

TABLE 4
Peel force (ASTM-D-3303) obtained with different adhesives
and die-cuts or raised portions in the film or backing.

| | | Adhesive power |
|---|---|---|
| Geometrical shape | Adhesive | (ounces/24 inch²) |
| Diamond | Pressure-sensitive acrylic | 20-35 |
| Square | Pressure-sensitive acrylic | 15-20 |
| Hexagon | Silicone-based adhesive | 5-10 |
| Flat surface | Silicone-based adhesive | 10-15 |

When the film or adhesive has a die-cut or raised proportion, the span between the geometrical shapes must be such that even after placing the adhesive, the gases, vapors or liquids can escape through the channels or ducts. As shown in FIG. 5, as long as there is enough space (v) for the adhesive to be placed without the space being flooded, the impurities that are also mixed with the gases) vapors or liquids will have an escape route. Based on the nature of the adhesive placed on the backing or film, with regard to its composition, amount of solids and viscosity, the span between the geometrical shapes of the film or backing will vary in order to keep flaws to a minimum in the protection application chosen.

For cases in which the adhesive or film backing has a die-cut or raised proportion, it is important to keep the spaces formed by the combination of the adhesive and the protected surface. An adhesive thickness that equals the depth of the die-cut or raised proportion in the film or backing will eliminate the channels or ducts through which the gases, vapors or liquids can escape. Likewise, a geometrical shape in which the space of the channels or ducts of the film borders are reduced, will also have a significant impact on the effectiveness of eliminating gases, vapors or liquids in the section formed by the adhesive and the substrate material. In all cases, the speed with which the gases, vapors or liquids are eliminated must determine the size of the channels or ducts used in the finished product. It is best to use a ratio of one half of the depth of the die-cut or raised proportion, and/or the distance between the geometrical shapes in the die-cut as the thickness of the adhesive placed to manufacture the product. Other ratios are valid for originating this invention based on the desired results.

It is also possible to add materials with the capacity to reduce electrostatics directly to the adhesive. These materials include silver, boron, gold, copper, tin, zinc, iron and vanadium salts and activated carbon with particle sizes ranging from about 150 and 200 microns in a concentration of 1 to 5% w/w, or micronized carbon black with particle size of about 1 to 50 microns in a concentration of 1 to 5% w/w. The name ‘micronized carbon black’ refers to carbon particles having a particle size of about 1 to 50 microns, and it is maintained for all references in this document. The latter materials are able to conduct electricity and distribute it throughout an area of the adhesive film, reducing its concentration in the surface treated. Conventional methods may be used to disperse the material, such as a propeller mixer, disk mixer, ribbon blender, blade mixer or any other method that facilitates dispersion of the particles. Mixing at between 3000 and 5000 revolutions per minute is good for dispersing these particles. Any person with knowledge of the technique will recognize that any other mixing system used to disperse the particles constitutes an extension of this invention. An agent to assist suspension may be also be used, such as surfacing agents, agents that form viscosity such as xanthate gum or dried silica, as well as polyurethane or acrylic thickeners.

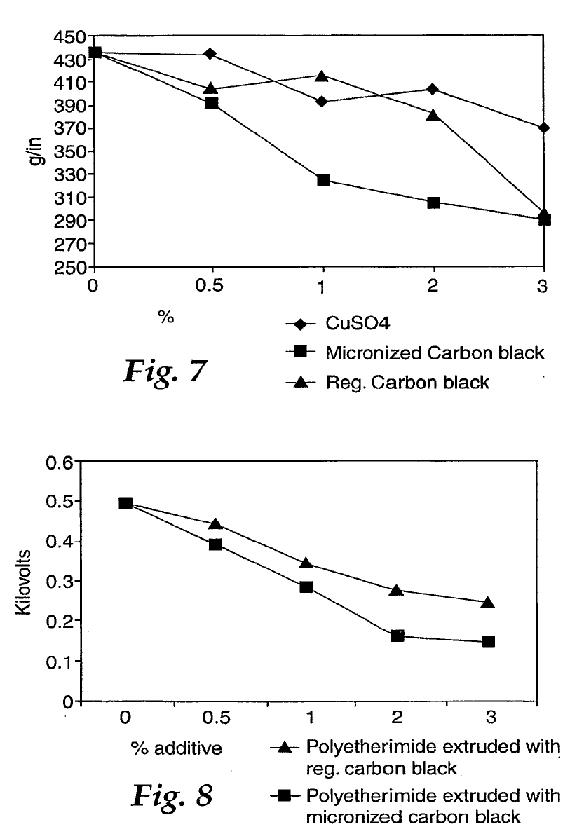

FIG. 6 shows how electrostatics is reduced when copper salts are added to a silicone adhesive; it is possible to reduce electrostatics to an acceptable level for applications in electronics. It may also be seen that the electrostatic reduction level becomes nearly constant with the increase in the micronized carbon black. This phenomenon is observed when concentrations of materials exceed 1.5% w/w. The amount of additives to reduce electrostatics, have to take into consideration the reduction in the adhesion of the adhesive solution that is prepared to make the tape. As seen in FIG. 7, raising the amount of additive causes a reduction in adhesion seen on stainless steel panel. The proper combination of electrostatic reduction and adhesion on a surface will have to select the amount of additives that will provide a convenient low electrostatic level and a sufficient adhesion performance.

It is also possible to review effect of electrostatics reduction when micronized carbon black or materials such as copper, silver, tin or gold salts are used directly in production of the polyetherimide film when cast or calendered. This effect is shown in FIG. 8, where it may be seen that the electrostatic reduction level becomes constant at nearly the same level as that seen in the adhesive (1.5% w/w).

A material such as vanadium pentoxide can reduce the electrostatics to an even greater extent, even though it shows the same tendency to reach a constant level at levels of approximately 1.5% w/w. It is possible to add this material to the adhesive or to the low adhesion agent; thus it is an alternative for reducing the electrostatics to values of 200 volts or below.

It is also possible to reduce the electrostatics formed by friction of the adhesive when it is unfastened from a section of the polyetherimide film surface, by adding the same materials as those used for the adhesive, but now placed through the low adhesion agent. The low adhesion agent is placed in order to be able to peel several layers of the adhesive film, one over the other, to make it easier to unfasten them. The components used to reduce the electrostatics are mixed in with the low adhesion agent in such a way that they are deposited in a very thin coat over the outside of the polyetherimide polymer film, so that they distribute the electrostatics formed by friction of the adhesive when it is unfastened from the film. The ingredients are blended in the same way as that described for the adhesive of this invention. Conductive acrylic adhesives, made up of molecules with carboxyl groups that permit electron conduction, such as acrylate, ethylhexyl and acrilamide derivatives, constitute another alternative. Yet another option is to add particles of the conductive materials listed above directly to the reaction of the formation of the polyetherimide polymer, in a concentration of between 0.5 and 1% w/w.

In order to place the adhesive, it is necessary to know the amount of solids of the formula, as well as the temperatures at which they will be placed. The tensions of the film or backing during placement of the adhesive will depend on the type of system in which it is applied. Thus the systems preferred for placing the adhesive do not limit the use of others known in the current status of the technique as shown in Table 5.

TABLE 5
Systems for placing the adhesive on the film or backing

| System | Some features |
|---|---|
| Extrusor and drop die | Medium speed for solvent-based adhesives |
| | (30-80 m/min) |
| Pumping and application | Organic solvent-based adhesives (toluene, |
| by roll coating | heptane, etc.) or water-based; medium-low |
| | speeds (up to 80 m/min) |
| Pumping and font die | Organic solvent-based adhesives (toluene, |
| | heptane, etc.) or water-based; medium-low |
| | speeds (up to 50 m/min) |

Roll coating systems with a gravure roll, 95 QCH stainless steel and diameter of 20-30 centimeters, at a speed of 20 meters per minute, may also be used to apply the adhesive.

The polyetherimide film with die-cut or raised proportion used in this invention can be manufactured with different mechanisms. It is also feasible to find them on the market, such as those offered by General Electric Polymers, Bloomer Plastics Company, 3M Company, Mitsubishi Polymers and Dupont Company, among others. The various compositions and physical properties make it possible to construct a wide range of protective films. The thickness and type of the film used to reinforce the materials are a very important factor in this invention. Likewise, the chemical nature of the film will be defined by the environmental conditions under which it will be used during reinforcement. A regular polyolefin film may be made more resistant to shearing or tearing when polyolefin, carbon or fiberglass fibers are placed in its structure. These fibers may be added through the same systems used to generate the polyolefin film, such as extrusion or lamination, or through application with the adhesive that has an affinity with the film and the fibers. The thickness of a film backing for this invention may range between 0.001 and 0.01 inches (0.0254 to 0.254 mm, but preferably 0.0254 mm) in order to achieve the protection, resistance and electrostatic reduction performance described. Its use will depend on the conditions under which it will be operating and the customer's needs with regard to cost and effectiveness. Any person familiar with the technique knows that an increase in the thickness of the film backing will depend on the resistance level and type of application sought. Thus, thickness of the polyetherimide film will permit to have better resistance to high temperatures by the adhesive tape made out if it, as seen in Table 6.

TABLE 6
Temperature resistance of the adhesive masking tape made with
polyetherimide film.

| Polyetherimide film | Type of adhesive (coated at | |
|---|---|---|
| thickness (inches) | 10 grams per square meter) | Heating conditions |
| 0.001 | Acrylic | 180° C., 6 hours |
| 0.002 | Silicone | 250° C., 3 hours |
| 0.002 | Silicone | 300° C., 3 minutes |

The data in Table 6 are only some examples demonstrating the temperature resistance and are not limitative of the combination of adhesive, thickness and conditions that derivate from them.

Current methods to promote an improved interaction to prevent the adhesive from being detached from the final product may be used to improve retention o adhesive on film or backing when constructing this invention. Some examples include the Corona treatment and application of a primer to the side on which the adhesive is to be placed. Both methods are well known within the current status of the technique. Their inclusion in this description is to serve as an example of the preferred methods for constructing this invention, but they should not be considered the only alternatives and any other method that makes it possible for the adhesive to stay on the film or backing of the product may also be used. Selection of the Corona treatment may vary up to 60 kilowatts on a width of 1.2 meters, or the equivalent in order to achieve a surface energy equal to 35 dynes; while the primer may be chosen from among a group of compounds that include acrylic products, ureas and natural or synthetic rubber derivatives (available from a number of companies, such as Dupont Company and 3M Company, among others).

Specific examples demonstrating construction of a high temperature heat resistant film are shown as follows.

### EXAMPLE 1

### High Temperature Heat Resistant Acrylic Adhesive Tape

An adhesive made of isooctyl acrylate and acrylamide compounds in a proportion of 90%/10% was placed on a polyetherimide polymer film that had a 1 millimeter circular raised portion, and a span of 0.5 millimeters between each circle. The amount of acrylic adhesive placed was sufficient to keep the adhesive at a thickness of approximately 0.25-0.3 millimeters. The adhesive was coated with a font die, which was fed with a peristaltic pump at a rate of 10-15 kilograms per minute. The adhesive solution had a viscosity of 3000 to 5000 centipoises and total solids of 40%. Construction was completed with placement of a low adhesion agent, RD1530 at 2% total solids from 3M Company, on the other side of the backing or film.

### EXAMPLE 2

### Reinforcement Tape for Welding of Electronic Plates

An adhesive composed of a silicone polymer made of siloxane polydimethyl and polysiloxane such as adhesive silicone 7925 from Dow Chemical, was placed in a weight of 20 g/m2 over a polyetherimide polymer film that has a flat surface 0.001 inch (0.0254 mm) thick. The adhesive was coated with a drop die with a lips gap of 0.02 to 0.03 inches, made of stainless steel and fed with a peristaltic pump at a rate of 20-25 kilograms per minute, to provide a continuous flow of adhesive in a gap of 0.01 to 0.015 inches from the surface of the polyetherimide film. Construction was completed with placement of a low adhesion agent, RD1530 at 2% total solids from 3M Company, on the other side of the backing or film, as in example 1.

### EXAMPLE 3

### High Temperature Heat Resistant Tape with High Static Reduction (<200 Volts)

An adhesive composed of a silicone polymer made of siloxane polydimethyl and polysiloxane as in Example 2, was placed in a weight of 20 g/m2 over a polyetherimide polymer film that had a 0.001 inches thick (0.0254 mm) flat surface. The adhesive was added to a vanadium pentoxide solution using a surfacing or thixotropic agent such as xanthate gum in a concentration of 2% w/w, and mixing it with a marine propeller at 3000 rpm for one hour. The adhesive was coated with a drop die with a lips gap of 0.03 to 0.045 inches, made of stainless steel and fed with a peristaltic pump at a rate of 20-25 Kg per minute, to provide a continuous flow of adhesive in a gap of 0.008 to 0.01 inches from the surface of the polyetherimide film. Construction was completed with placement of a low adhesion agent, RD1530 at 2% total solids from 3M Company, on the other side of the backing or film, as in Example 1.

### EXAMPLE 4

### High Temperature Heat Resistant Tape with Medium Static Reduction (>200 Volts)

An adhesive composed of a silicone polymer made of siloxane polydimethyl and polysiloxane as in example 2, was placed in a weight of 20 grams per square meter, over a polyetherimide polymer film that had a flat surface 0.001 inches thick (0.0254 mm). The adhesive was added with micronized carbon black, which was made by adding these latter components and a thixotropic agent such as xanthate gum in a concentration of 2% w/w in toluene, and mixing with a marine propeller at 3000 rpm for one hour. The adhesive solution was coated with a font die, which was fed with a peristaltic pump at a rate of 15-20 kilograms per minute. The adhesive solution had a viscosity of 3000-5000 centipoises and total solids of 50%. Construction was completed with placement of a low adhesion agent, RD1530 at 2% total solids from 3M Company, on the other side of the backing or film, as in Example 1.

### EXAMPLE 5

### High Temperature Heat Resistant Tape with Micro-Replicated Acrylic Adhesive

An adhesive composed of a silicone polymer made of isooctyl acrylic and acrylamide compounds in a proportion of 95%/5%, was placed in a weight of 20 grams per square meter over a polyetherimide polymer film that had a flat surface 0.003 inches thick (0.0762 mm). The adhesive was diluted with ethyl acetate to place it on a piece of 0.05 mm by 0.05 mm release paper that had a micro-replicated net pattern in such a way that the net was created by squares of 0.05 mm in length and 0.05 mm in width. The pattern was then replicated throughout the adhesive surface including the 0.001 mm deep channels separating the squares in the net. The adhesive was coated on the release paper with a font die, which was fed with a peristaltic pump at a rate of 10 to 15 kilograms per minute. The adhesive solution had a viscosity of 3000-5000 centipoises and total solids of 40%. The coated paper was then placed onto the surface of the polyetherimide film using a winder machine running at 20 to 25 meters per minute, and which has two cylinders of 60 to 70 centimeters in diameter and 162 centimeters in length, rotating at the same speed and pressing the paper on the polyetherimide film. The resultant product was a tape where the micro-replicated adhesive was transferred from the release paper to the polyetherimide film. The release paper is obtained from the line of products Scotch Cal®, manufactured by 3M Company, St. Paul, Minn., USA.

Various modifications and changes in this invention will be apparent to persons familiar with the technique, even though they may not explicitly arise from all of its objectives and principles. It must also be understood that this invention is not restricted to the examples shown herein.

### SUMMARY OF THE INVENTION

In this invention a description is provided of a high temperature heat resistant adhesive tape made from a polyetherimide polymer film, with or without a die-cut or raised proportion surface in various geometrical shapes and sizes, which makes it possible to release the fluids retained between the protected surface and the adhesive. The adhesive film acts as a backing for one adhesive that facilitates connection to the substrate and maintains its stability, along with that of the film, under temperatures up to 220° C. This makes the adhesive tape an alternative for protecting or insulating surfaces such as electronic or electrical circuits. Compounds such as derivatives of organometallic derivatives, boron, carbon or micronized carbon black may be added to the adhesive in order to reduce the electrostatics caused by friction between the adhesive and the polyetherimide coating, either alone or with a different surface. These compounds may also be added to the film during the production process or when the low adhesion agent is placed on the film when the adhesive tape is manufactured.

1. A heat-resistant masking tape suitable for electronics applications comprising a polyetherimide polymer film having a first surface and a second surface, an adhesive on the first surface, and a low adhesion agent on the second surface, wherein at least one of the polyetherimide film, the low adhesion agent and the adhesive includes micronized carbon black.

2. The tape of claim 1 wherein the first surface of the polyetherimide polymer film is a flat surface having thereon raised portions.

3. The tape of claim 1 wherein the thickness of the raised portions on the polyetherimide polymer film is different from the thickness of the base of the film such that the ratio of the maximum thickness of the raised portion to the thickness of the base of the film is from about 2 to 1, to about 4 to 1.

4. The tape of claim 1 wherein the raised portion of the polyetherimide polymer film comprises 10 to 95% of the area of the first surface.

5. The tape of claim 1 wherein the amount of adhesive on the polyetherimide polymer film ranges between about 5 and about 50 grams per square meter.

6. The tape of claim 1 wherein the raised portions of the polyetherimide polymer film comprises at least one geometrical shape, optionally selected from ellipses, circles, hexagons, rectangles, squares, triangle, diamonds, and trapezoids.

7. The tape of claim 1 wherein the adhesive is a pressure sensitive adhesive.

8. The tape of claim 1 wherein the adhesive is resistant to temperatures ranging between −20 degrees Centigrade and 300 degrees Centigrade.

9. The tape of claim 1 wherein polyetherimide polymer film remains intact at temperatures ranging between −20 degrees Centigrade and 220 degrees Centigrade.

10. The tape of claim 1 wherein one of its sides has an anti-stick compound optionally silicone and silicone-urea.

11. The tape of claim 1 wherein at least one of the surfaces of the polyetherimide polymer film is modified with a corona treatment, an acrylic compound or an urethane compound.

12. The tape of claim 1 wherein the adhesive is an acrylic adhesive, optionally combinations of isooctyl acrylate or 2-ethylhexyl acrylate with acrylamide or acrylic acid, methacrylates.

13. The tape of claim 1 wherein the adhesive is a silicone adhesive, optionally polydimethylsiloxane or polysiloxane resin rubbers.

14. The tape of claim 1 wherein the raised portions of the polyetherimide polymer film have sloped or vertical side walls.

15. The tape of claim 1 wherein the adhesive and/or the polyetherimide polymer film further comprises a component to reduce electrostatic charges optionally wherein the component is selected from silver, boron, gold, copper, tin, zinc, iron, vanadium, alkaline-earth metal derivatives, activated carbon, graphite compounds, and combinations thereof.

16. A process to produce the tape according to claim 1 comprising providing a polyetherimide polymer film, and applying a thin adhesive coat onto the film.

17. A process for making the polyetherimide polymer film of claim 1 comprising extruding or casting.

18. An electronic circuit having thereon a tape of claim 1.
